(19) United States
(12) Patent Application Publication
(10) Pub. No.: US 2022/0409476 A1
(43) Pub. Date: Dec. 29, 2022

(54) MASSAGE MOVEMENT AND MASSAGE CUSHION

(71) Applicant: Jiangsu Mingteng Health Products Co., Ltd, Yancheng (CN)

(72) Inventors: Chuankui Du, Shanghai (CN); Saihua Chen, Shanghai (CN); Jinnian Dong, Shanghai (CN)

(73) Assignee: Jiangsu Mingteng Health Products Co., Ltd, Yancheng, JS (CN)

(21) Appl. No.: 17/902,927

(22) Filed: Sep. 5, 2022

(30) Foreign Application Priority Data
Jul. 26, 2022 (CN) 202221928083.7

(51) Int. Cl. A61H 15/00

(52) U.S. Cl. CPC A61H 15/0078; A61H 2015/0057; A61H 2015/0042; A61H 2201/1215

(57) ABSTRACT

The present disclosure provides a massage movement. The massage movement includes an upper shell, and a lower shell fixed on the upper shell; further includes: a motor, a transmission assembly, disk gears and rotating turntables. A plurality of round recesses are pre-arranged on upper shell, and are distributed on a left column and a right column; rotating turntables are mounted in round recesses; and upper shell is fixedly connected to lower shell. A massage member is in contact with a part to be massaged; a motor simultaneously drives one disk gear of two columns of disk gears to rotate through the transmission assembly; by means of meshing fit of the plurality of disk gears, all the disk gears rotate; the disk gears drive the rotating turntables to rotate through shaft pins; and the rotating turntables drive the massage member to rotate to massage the part to be massaged.

### TECHNICAL FIELD

The present disclosure belongs to the field of massage apparatuses, and particularly relates to a massage movement and a massage cushion.

### BACKGROUND

In modern life, many people often suffer from soreness of waist, leg pain, cervical spondylosis, hypertrophy of the buttocks, and poor blood circulation in the legs due to long-term fatigue, long-term sitting, high mental stress, and poor rest.

There are many special massagers on the market, but people usually hope that there is a multi-functional massager that can simultaneously massage the soles, legs, buttocks, shoulders and abdomen. Massage movements of general massagers on the current market all include a small number of massage heads, have a small massage area, and are relatively thick, so the use effect is not ideal.

### SUMMARY

An embodiment of the present disclosure aims to provide a massage movement and aims at solving the following problems: a massage movement of a universal massager includes a small number of massage heads, has a small massage area and is thick.

The embodiment of the present disclosure is achieved below. The massage movement includes an upper shell, and a lower shell fixed on the upper shell; further includes: a motor, a transmission assembly, disk gears and rotating turntables.

A plurality of round recesses are pre-arranged on the upper shell, and are distributed on a left column and a right column; the rotating turntables are mounted in the round recesses; the upper shell is fixedly connected to the lower shell; a cavity is formed between the upper shell and the lower shell; the disk gears are arranged in the cavity; circle centers of the disk gears are fixedly connected to circle centers of the rotating turntables through shaft pins; the disk gears and the rotating turntables are respectively rotatably connected to two ends of the upper shell through shaft pins; the two columns of disk gears are respectively meshed in series; the motor and the transmission assembly are located between the two columns of disk gears; the motor drives the two columns of disk gears to rotate through the transmission assembly; and massage members are arranged on the rotating turntables.

In a further technical solution, each massage member includes spherical balls; and a plurality of spherical balls are arranged on the rotating turntables.

In a further technical solution, the spherical balls are movably connected to the rotating turntables.

In a further technical solution, an apex of each spherical ball is higher than the upper shell.

In a further technical solution, the transmission assembly includes a first transmission gear, a second transmission gear, a rotating shaft and a worm wheel; a rotating end of the motor is a worm; the rotating shaft is rotatably connected into the upper shell and the lower shell; the first transmission gear and the worm wheel are of an integrated structure and are rotatably mounted and fixed on the rotating shaft; the worm wheel and the worm of the motor are in meshing fit; the first transmission gear and the second transmission gear are in meshing fit; and the second transmission gear is in meshing fit with one disk gear of the two columns of disk gears.

In a further technical solution, the massage movement includes at least six groups of rotating turntables and disk gears.

A massage cushion includes the massage movement.

According to the massage movement provided in the embodiment of the present disclosure, a massage member is in contact with a part to be massaged; a motor simultaneously drives one disk gear of two columns of disk gears to rotate through the transmission assembly; by means of meshing fit of the plurality of disk gears, all the disk gears rotate; the disk gears drive the rotating turntables to rotate through shaft pins; and the rotating turntables drive the massage member to rotate to massage the part to be massaged. By the arrangement of the plurality of rotating turntables, a massage area is enlarged. At the same time, the massage movement is convenient to use due to a small thickness.

### BRIEF DESCRIPTION OF THE DRAWINGS

FIG. 1 is a schematic diagram of a finished product of a massage movement provided in Embodiment I of the present disclosure;

FIG. 2 is a schematic diagram of an internal transmission structure of a massage movement provided in Embodiment I of the present disclosure;

FIG. 3 is an exploded diagram of a massage movement provided in Embodiment I of the present disclosure;

FIG. 4 is a schematic diagram of an amplified structure of A in FIG. 3 according to Embodiment I of the present disclosure;

FIG. 5 is a schematic diagram of a massage cushion provided in Embodiment II of the present disclosure.

In the drawings: upper shell 1, lower shell 2, motor 3, worm wheel 4, disk gear 5, rotating turntable 6, spherical ball 7, second transmission gear 8, first transmission gear 9, rotating shaft 10, and transmission assembly 11.

### DETAILED DESCRIPTION OF THE EMBODIMENTS

In order to make the objectives, technical solutions and advantages of the present disclosure clearer, the present disclosure is further described in detail below with reference to accompanying drawings and embodiments. It should be understood that the specific embodiments described here are merely to illustrate and explain the present disclosure, and not intended to limit the present disclosure.

Specific implementation of the present disclosure is described in detail below in combination with specific embodiments.

### Embodiment I

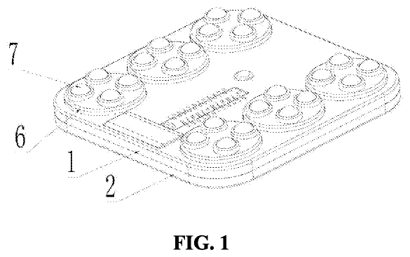

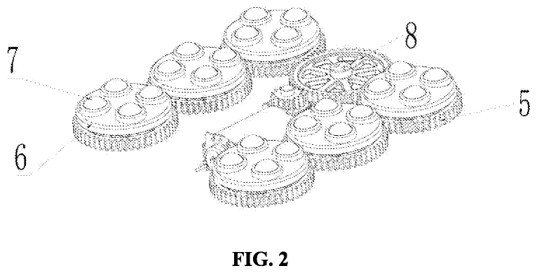

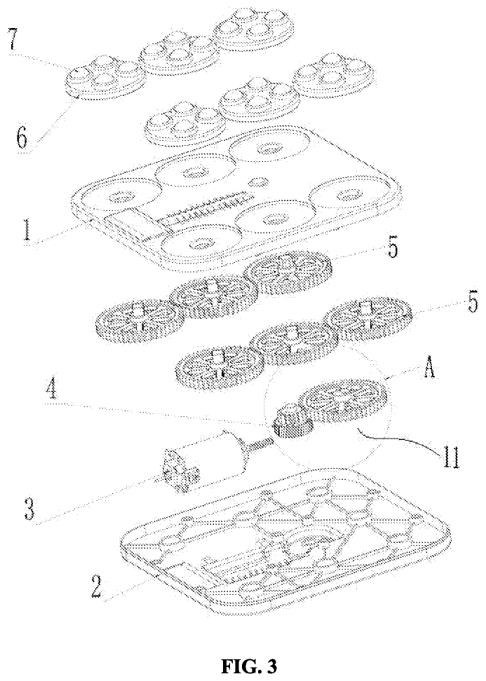

As shown in FIG. 1 to FIG. 3, a massage movement provided in one embodiment of the present disclosure includes an upper shell 1, and a lower shell 2 fixed on the upper shell 1; further includes: a motor 3, a transmission assembly 11, disk gears 5 and rotating turntables 6.

A plurality of round recesses are pre-arranged on the upper shell 1, and are distributed on a left column and a right column; the rotating turntables 6 are mounted in the round recesses; the upper shell 1 is fixedly connected to the lower shell 2; a cavity is formed between the upper shell 1 and the lower shell 2; the disk gears 5 are arranged in the cavity; circle centers of the disk gears 5 are fixedly connected to circle centers of the rotating turntables 6 through shaft pins; the disk gears 5 and the rotating turntables 6 are respectively rotatably connected to two ends of the upper shell 1 through shaft pins; the two columns of disk gears 5 are respectively meshed in series; the motor 3 and the transmission assembly 11 are mounted between the upper shell 1 and the lower shell 2, and the motor 3 and the transmission assembly 11 are both located between the two columns of disk gears 5; the motor 3 drives the two columns of disk gears 5 to rotate through the transmission assembly 11; and massage members are arranged on the rotating turntables 6.

In the embodiment of the present disclosure, during use, the massage members are in contact with parts to be massaged; the motor 3 simultaneously drives one disk gear 5 of two columns of disk gears 5 to rotate through the transmission assembly 11; by means of the meshing fit of the plurality of disk gears 5, all the disk gears 5 rotate; the disk gears 5 drive the rotating turntables 6 to rotate through the shaft pins; and the rotating turntables 6 drive the massage members to rotate to massage the parts to be massaged. By the arrangement of the plurality of rotating turntables 6, a massage area is enlarged. At the same time, the massage movement is convenient to use due to a small thickness.

As shown in FIG. 1 to FIG. 3, as one preferable embodiment of the present disclosure, each massage member includes spherical balls 7; and a plurality of spherical balls 7 are arranged on the rotating turntables 6.

In the embodiment of the present disclosure, the massage effect is enhanced by means of disposing the plurality of spherical balls 7.

As shown in FIG. 1 to FIG. 3, as one preferable embodiment of the present disclosure, the spherical balls 7 are movably connected to the rotating turntables 6.

In the embodiment of the present disclosure, the spherical balls 7 are movably arranged on the rotating turntables 6, so that the spherical balls 7 can freely rotate in multiple directions to enhance the massage effect.

As shown in FIG. 1 to FIG. 3, as one preferable embodiment of the present disclosure, an apex of each spherical ball 7 is higher than the upper shell 1.

In the embodiment of the present disclosure, the apex of each spherical ball 7 is higher than the upper shell 1, so that the spherical ball 7 is in contact with the part to be massaged.

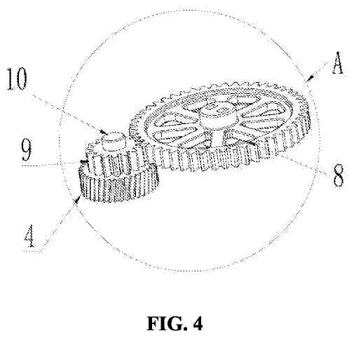

As shown in FIG. 1 to FIG. 4, as one preferable embodiment of the present disclosure, the transmission assembly 11 includes a first transmission gear 9, a second transmission gear 8, a rotating shaft 10 and a worm wheel 4; a rotating end of the motor 3 is a worm; the rotating shaft 10 is rotatably connected into the upper shell 1 and the lower shell 2; the first transmission gear 9 and the worm wheel 4 are of an integrated structure and are rotatably mounted and fixed on the rotating shaft 10; the worm wheel 4 and the worm of the motor 3 are in meshing fit; the first transmission gear 9 and the second transmission gear 8 are in meshing fit; and the second transmission gear 8 is in meshing fit with one disk gear 5 of the two columns of disk gears 5.

In the embodiment of the present disclosure, the motor 3 drives the worm to rotate, and the worm drives the worm wheel 4 to rotate; the worm wheel 4 drives the first transmission gear 9 to rotate; the first transmission gear 9 drives the second transmission gear 8 to rotate; and the second transmission gear 8 simultaneously drives one of the two columns of disk gears 5 to rotate.

As shown in FIG. 1 to FIG. 3, as one preferable embodiment of the present disclosure, the massage movement includes at least six groups of rotating turntables 6 and disk gears 5.

In the embodiment of the present disclosure, the massage range is enlarged by disposing six or more rotating turntables 6 to enhance the massage effect.

In the above embodiment of the present disclosure, the massage movement is provided. During use, the massage members are in contact with parts to be massaged; the motor 3 drives the worm to rotate, and the worm drives the worm wheel 4 to rotate; the worm wheel 4 drives the first transmission gear 9 to rotate; the first transmission gear 9 drives the second transmission gear 8 to rotate; and the second transmission gear 8 simultaneously drives one of the two columns of disk gears 5 to rotate. By the meshing fit of the plurality of disk gears 5, all the disk gears 5 rotate. The disk gears 5 drive the rotating turntables 6 to rotate through the shaft pins, and the rotating turntables 6 drive the spherical balls 7 to rotate, so as to massage the parts to be massaged. The spherical balls 7 are movably arranged on the rotating turntables 6, so that the spherical balls 7 can freely rotate in multiple directions to enhance the massage effect. By the arrangement of the plurality of rotating turntables 6, a massage area is enlarged. At the same time, the massage movement is convenient to use due to a small thickness.

### Embodiment II

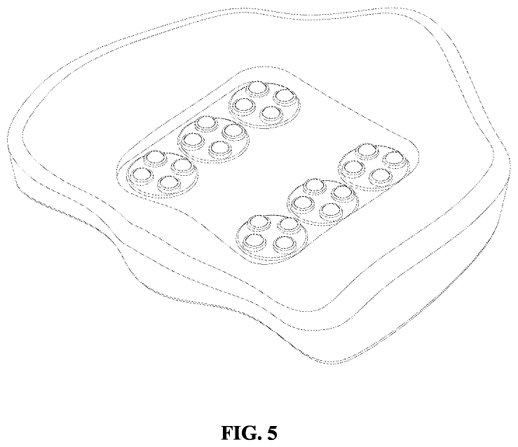

This embodiment provides a massage cushion. As shown in FIG. 5, the massage cushion includes a massage cloth cover and a sponge liner. A square groove is formed in the middle of the sponge liner. One massage movement is mounted in the groove. The massage movement is the massage movement of Embodiment I.

The above descriptions are only the preferred embodiments of the present utility model, and are not intended to limit the present utility model. Any modifications, equivalent replacements and improvements that are made within the spirit and principle of the present utility model shall fall within the protection scope of the present utility model.

What is claimed is:

1. A massage movement, comprising an upper shell, and a lower shell fixed on the upper shell, further comprising: a motor, a transmission assembly, disk gears and rotating turntables, wherein
a plurality of round recesses are pre-arranged on the upper shell, and are distributed on a left column and a right column; the rotating turntables are mounted in the round recesses; the upper shell is fixedly connected to the lower shell; a cavity is formed between the upper shell and the lower shell; the disk gears are arranged in the cavity; circle centers of the disk gears are fixedly connected to circle centers of the rotating turntables through shaft pins; the disk gears and the rotating turntables are respectively rotatably connected to two ends of the upper shell through shaft pins; the two columns of disk gears are respectively meshed in series; the motor and the transmission assembly are mounted between the upper shell and the lower shell, and the motor and the transmission assembly are located between the two columns of disk gears; the motor drives the two columns of disk gears to rotate through the transmission assembly; and massage members are arranged on the rotating turntables.

2. The massage movement according to claim 1, wherein each massage member comprises spherical balls; and a plurality of spherical balls are arranged on the rotating turntables.

3. The massage movement according to claim 2, wherein the spherical balls are movably connected to the rotating turntables.

4. The massage movement according to claim 2, wherein an apex of each spherical ball is higher than the upper shell.

5. The massage movement according to claim 1, wherein the transmission assembly comprises a first transmission gear, a second transmission gear, a rotating shaft and a worm wheel; a rotating end of the motor is a worm; the rotating shaft is rotatably connected into the upper shell and the lower shell; the first transmission gear and the worm wheel are of an integrated structure and are rotatably mounted and fixed on the rotating shaft; the worm wheel and the worm of the motor are in meshing fit; the first transmission gear and the second transmission gear are in meshing fit; and the second transmission gear is in meshing fit with one disk gear of the two columns of disk gears.

6. The massage movement according to claim 5, wherein the massage movement comprises at least six groups of rotating turntables and disk gears.

7. A massage cushion, comprising the massage movement according to claim 1.
